(19) United States
(12) Patent Application Publication
(10) Pub. No.: US 2026/0013506 A1
(43) Pub. Date: Jan. 15, 2026

(54) COMPOSITION WITH REDUCED SALT CONCENTRATION FOR PRODUCING A BIOCIDE

(71) Applicant: NM 5473 LTD., Tel Aviv (IL)

(72) Inventor: Ayala Barak, Tel Aviv (IL)

(21) Appl. No.: 18/994,270

(22) PCT Filed: Aug. 9, 2023
(86) PCT No.: PCT/IL2023/050824

§ 371 Date: Jan. 14, 2025

Related U.S. Application Data
(60) Provisional application No. 63/398,558, filed on Aug. 17, 2022.

(51) Int. Cl. A01N 59/00; A01N 25/02; A01P 1/00

(52) U.S. Cl. CPC A01N 59/00; A01N 25/02; A01P 1/00

(57) ABSTRACT

A composition for producing a biocide is provided. The composition comprises an ammonium salt, aqueous ammonia and sodium bicarbonate. The composition can be mixed with a hypochlorite oxidant to form a biocide. Previously known compositions included only an ammonium salt and optionally a base. The present composition is more economically favorable and has a more optimum pH relative to previously known compositions comprising an ammonium salt of a strong acid (hydrobromic, hydrochloric or sulfuric) or comprising ammonium carbamate and sodium hydroxide. Preparation of the biocide can be monitored with a control parameter. A new control parameter, the ratio ORP/pH, is introduced.

### CROSS-REFERENCE TO RELATED APPLICATIONS

Reference is made to U.S. Provisional Patent Application Ser. No. 63/398,558, filed Aug. 17, 2022 and entitled METHOD FOR PRODUCING A BIOCIDE WITH LOW SALT CONTENT, the disclosure of which is hereby incorporated by reference and priority of which is hereby claimed pursuant to 37 CFR 1.78(a)(4) and (5)(i).

Reference is made to U.S. patent application Ser. No. 07/892,533, filed Jun. 1, 1992 and entitled PROCESS AND COMPOSITIONS FOR THE DISINFECTION OF WATERS, U.S. patent application Ser. No. 08/809,346, filed Jan. 27, 1998 and entitled METHOD AND APPARATUS FOR TREATING LIQUIDS TO INHIBIT GROWTH OF LIVING ORGANISMS, U.S. patent application Ser. No. 10/586,349, filed Jul. 14, 2006 and entitled BIOCIDES AND APPARATUS, U.S. patent application Ser. No. 14/765,335, filed Aug. 1, 2015 and entitled METHOD FOR CONTROLLING THE PRODUCTION OF A BIOCIDE, U.S. patent application Ser. No. 17/621,014, filed Dec. 20, 2021 and entitled METHOD FOR PRODUCING A BIOCIDE, and U.S. patent application Ser. No. 17/619,851, filed Dec. 16, 2021, and entitled PROCESS FOR PRODUCING A SOLUTION OF AMMONIUM CARBAMATE, the disclosures of which are hereby incorporated by reference.

### FIELD OF THE INVENTION

The present invention relates to a composition for producing a biocide having a lower salt concentration relative to previously known biocide forming compositions.

### BACKGROUND OF THE INVENTION

Various compositions and techniques are known for producing chloramines from ammonium salts for use as biocides.

### SUMMARY OF THE INVENTION

The present invention seeks to provide a composition useful for producing a biocide.

There is thus provided in accordance with a preferred embodiment of the present invention a composition for preparing a biocide, the composition including: an ammonium salt including ammonium and an anion; aqueous ammonia; and sodium bicarbonate; wherein a total molar amount of ammonia and ammonium in the composition exceeds an equivalent molar amount of the anion in the composition by at least 10%; wherein the equivalent molar amount of the anion is a molar amount of the anion multiplied by its valence.

In accordance with one preferred embodiment of the present invention, the ammonium salt is selected from the group consisting of ammonium bicarbonate, ammonium bromide, ammonium carbamate, ammonium carbonate, ammonium chloride, ammonium phosphate, ammonium sulfamate and ammonium sulfate. Preferably, the ammonium salt is selected from the group consisting of ammonium bromide, ammonium carbamate, ammonium chloride and ammonium sulfate. Most preferably, the ammonium salt is ammonium bromide or ammonium carbamate.

In accordance with another preferred embodiment of the present invention, the composition is an aqueous solution including the ammonium salt at a concentration in a range of about 4% w/w to about 36% w/w, preferably at a concentration in a range of about 5% w/w to about 27% w/w.

In accordance with a different preferred embodiment of the present invention, the molar ratio of the ammonium salt to the aqueous ammonia is in a range of about 1:10 to about 10:1, more preferably in a range of about 1:3 to about 3:1. Preferred embodiments of the present invention include those wherein the molar ratio of the ammonium salt to the aqueous ammonia is about 1:3, about 1:2, about 1:1, about 2:1 or about 3:1.

In accordance with one preferred embodiment of the present invention, the concentration of the aqueous ammonia is in a range of about 1% w/w to about 21% w/w, preferably in a range of about 2% w/w to about 7% w/w. Preferably, the concentration of the sodium bicarbonate is in a range of about 0.2% w/v to about 10% w/v more preferably a range of about 1% w/v to about 5% w/v, and most preferably about 2.7% w/v.

In accordance with one preferred embodiment of the present invention, the molar amount of ammonia/ammonium exceeds the equivalent molar amount of the anion by at least 20%. In another preferred embodiment, the molar amount of ammonia/ammonium exceeds the equivalent molar amount of the anion by at least 25%. Further preferred embodiments include those wherein the molar amount of ammonia/ammonium exceeds the equivalent molar amount of the anion by at least 33%, at least 50, at least 100, least 200 or at least 300%.

There is also provided in accordance with a preferred embodiment of the present invention a method of producing a biocide, including: providing a solution of a hypochlorite oxidant; providing a composition, the composition including: an ammonium salt including ammonium and an anion; aqueous ammonia; and sodium bicarbonate; wherein a total molar amount of ammonia and ammonium in the composition exceeds an equivalent molar amount of the anion in the composition by at least 10%; wherein the equivalent molar amount of the anion is a molar amount of the anion multiplied by its valence; and mixing the solution of a hypochlorite oxidant with the composition.

In accordance with one preferred embodiment of the present invention, the hypochlorite oxidant is sodium hypochlorite. Preferably, the solution of a hypochlorite oxidant has a concentration in a range of about 1000 to about 20,000 ppm, more preferably in a range of about 3000 to about 10,000 ppm, and most preferably in a range of about 3500 to about 7000 ppm.

Preferably, the ammonium salt is selected from the group consisting of ammonium bicarbonate, ammonium bromide, ammonium carbamate, ammonium carbonate, ammonium chloride, ammonium phosphate, ammonium sulfamate and ammonium sulfate. More preferably, the ammonium salt is selected from the group consisting of ammonium bromide, ammonium carbamate, ammonium chloride and ammonium sulfate. Most preferably, the ammonium salt is selected from the group consisting of ammonium bromide and ammonium carbamate.

In accordance with one preferred embodiment of the present invention, the composition is prepared by: combining an ammonium salt stock solution, an aqueous ammonia stock solution and sodium bicarbonate to form a mixture; and diluting the mixture with water or with the solution of a hypochlorite oxidant. The ammonium salt stock solution preferably has a concentration in a range of about 15% w/w to about 50% w/w, more preferably in a range of about 20% w/w to about 35% w/w.

Preferably, the aqueous ammonia stock solution has a concentration in a range of about 4% w/w to about 28% w/w, and more preferably a concentration of about 8.33% w/w. The ammonium salt stock solution and the aqueous ammonia stock solution are preferably equimolar. Preferably, a molar ratio of the ammonium salt to the aqueous ammonia in the mixture is in a range of about 1:10 to about 10:1, more preferably in a range of about 1:3 to about 3:1.

In accordance with one preferred embodiment of the present invention, the concentration of the sodium bicarbonate in the mixture is in a range of about 0.2% w/v to about 10% w/v, more preferably in a range of about 1% w/v to about 5% w/v. Preferably, the method further includes monitoring a control parameter during the mixing. The control parameter is preferably selected from the group consisting of pH, oxidation-reduction potential (ORP), conductivity, dissolved oxygen saturation, and a ratio ORP/pH. In one preferred embodiment, the control parameter is the ratio ORP/pH.

In accordance with another preferred embodiment, the control parameter is conductivity. Preferably, the mixing includes adding the solution of a hypochlorite oxidant to the composition; and ceasing to add the solution of a hypochlorite oxidant when the conductivity reaches a relative maximum. Preferably, the conductivity reaches a relative minimum prior to reaching the relative maximum. In a preferred embodiment, the pH of the biocide remains below 12.5.

### DETAILED DESCRIPTION OF THE INVENTION

As described in published European Patent Publication No. 0 517 102, the contents of which are incorporated herein by reference, biological fouling of circulating water is a well-known problem caused by algae, fungi, bacteria, and other simple life forms found in circulating water. That patent publication describes controlling biofouling in high chlorine demand waters by mixing two components, one of which is an oxidant and the other an ammonium salt, and adding the mixture substantially immediately to the aqueous system to be treated. This produces the active biocidal ingredient, as described therein. A large number of examples of oxidants and ammonium salts are described in that patent publication.

A problem encountered in this method of treating liquid to inhibit growth of living organisms, however, is that the concentrated active biocidal ingredient is extremely non-stable chemically and quickly decomposes upon formation with the result that there is a fast drop in pH. This is especially so for the active biocidal ingredients derived from ammonium bromide where the decomposition results in the undesirable formation of HOBr and other degradation byproducts. Therefore, when conventional dosing pumps and mixers are used, the formed active biocidal ingredient quickly decomposes and loses its efficacy. Also, while the pH range of such concentrated active biocide is theoretically 9.5-11.0, actually the pH can be as low as 8.0 because of the fast decomposition. In addition, the ammonium salts were supplied in excess in order to decrease the decomposition rate.

In U.S. Pat. No. 5,976,386, the contents of which are incorporated herein by reference, a method and apparatus for producing a biocide are disclosed that enable a constant ratio of oxidant/amine source to be maintained, thereby avoiding the need to use excess amine source in order to stabilize the reaction product and to maintain a reproducible product containing almost no degradation products. The novel method described therein includes producing an efficient in situ dilution of both the oxidant and the amine source and synchronously metering the two dilutions into a conduit to continuously mix therein according to a predetermined ratio to produce an active biocidal ingredient. The predetermined ratio was an amine to oxidant ratio of at least 1:1.

As already described in U.S. Pat. No. 5,976,386, careful control of the biocide formation is necessary. The biocide production process uses a multiple feeding point system requiring a separate control for each feed line since different pumps respond differently to pressure change, and pump feed rates depend on the water flow pressure. As for any on-site process, an online control is needed to ensure production of the right product at high yield, and with minimal side products. Furthermore, the above referenced patents disclose that equimolar amounts of ammonium and hypochlorite are necessary for optimal performance. The components used to make the biocide, such as sodium hypochlorite and ammonium carbamate, disclosed in U.S. Pat. No. 7,837,883, the contents of which are incorporated herein by reference, are unstable chemicals, and degrade with time during use. As a result, operating the feeding unit under pre-determined constant feed rates of the two reagents will produce variable products. In addition, other parameters such as water temperature, excessively high pH, high concentration of the produced biocide and water quality can enhance degradation of the biocide. This can be a severe problem if the alkalinity of the NaOCl is too high. Specifically for biocides prepared from ammonium carbamate, it has been demonstrated that producing the biocide in the presence of excess free ammonia impairs the biocide efficacy.

In U.S. Pat. No. 5,976,386 is disclosed the use of pH as an indicator of the end point of the reaction between an ammonium salt and sodium hypochlorite. Addition of hypochlorite to an ammonium salt solution increases the pH. However, after the equimolar point is reached and all the ammonium salt has reacted, the hypochlorite begins to degrade the biocidal MCA forming inorganic acids, which lower the pH. Thus, pH can be used as an indicator of the end point. However, pH was found to be an accurate indicator only at relatively low pH values. As biocide production takes place at relatively high pH, there was a need for other indicators.

U.S. Pat. No. 9,801,384, the contents of which are incorporated herein by reference in their entirety, discloses additional parameters which can be used to indicate the end point of the reaction between an ammonium salt and a hypochlorite oxidant. Specifically, oxidation-reduction potential (ORP), conductivity and induction were all shown to have a relative minimum at the end point. Dissolved oxygen was shown to have a constant value during the reaction and to rapidly decrease at the end point. These parameters were shown to be effective in identifying the end point of the reaction, with the assumption that if the end point was missed and excess hypochlorite was added, the result would be decomposition of the biocide, loss of efficacy and production of undesired degradation byproducts.

Even when using the precise amount of the ammonium salt, the salt is a relatively expensive component. Ammonium salts are significantly more expensive than ammonia, available as an aqueous solution, also known as ammonium hydroxide. While it is the ammonium part of the ammonium salt that reacts with hypochlorite to form the monochloramine biocide, and the counterion to ammonium is thought to not have an obvious role in the biocidal activity, it has been found that biocides made from aqueous ammonia and hypochlorite have lower biocidal activity than those made from ammonium salts. Use of aqueous ammonia for producing chloramine also is known to be used in large fresh water disinfecting plants. However, it presents logistical problems in industrial applications because of the physical properties of the aqueous ammonia solution. The pH of the aqueous ammonia solution is so high that the produced monochloramine degrades during production. There is also a continuous loss of ammonia from the aqueous ammonia solution, making it an impractical option for most industrial applications. It would be economically advantageous if at least part of the ammonium salt, such as ammonium bromide, ammonium carbamate, ammonium sulfate or ammonium chloride, could be replaced with aqueous ammonia without a reduction in the activity of the biocide produced therewith. Reducing the counterion content can also mitigate other problems, such as corrosion potential of chloride for biocides made from ammonium chloride) and growth of sulfate reducing bacteria for biocides made from ammonium sulfate.

The quality of sodium hypochlorite solution presents an additional problem in making the monochloramine biocide. Sodium hypochlorite is formed from the reaction of chlorine gas and sodium hydroxide. The formed solution contains alkalinity in the form of residual sodium hydroxide. The alkalinity of the sodium hypochlorite solution is typically about 0.7-0.8%, but it can vary significantly and be very low (0.1-0.3%) or extremely high (up to 3%). Low alkalinity interferes with the production of monochloramine from ammonium salts derived from strong acids, such as ammonium bromide, ammonium chloride and ammonium sulfate. When the alkalinity is too high, it may affect all ammonium salts, but specifically affects ammonium salts derived from weak acids, such as ammonium carbamate and ammonium carbonate. Replacing some of the salt with aqueous ammonia increases the tolerance of the ammonium salt to the alkalinity of the hypochlorite solution, and in practical terms improves the efficacy of the biocide significantly.

In accordance with a first embodiment of the present invention, there is provided a composition useful for producing a biocide, the composition comprising an ammonium salt, aqueous ammonia and sodium bicarbonate.

The ammonium salt is preferably selected from ammonium bicarbonate, ammonium bromide, ammonium carbamate, ammonium carbonate, ammonium chloride, ammonium phosphate, ammonium sulfamate and ammonium sulfate. More preferably, the ammonium salt is selected from ammonium bromide, ammonium carbamate, ammonium chloride and ammonium sulfate. Even more preferably, the ammonium salt is selected from ammonium bromide and ammonium carbamate. The ammonium salt is preferably provided as an aqueous solution at a concentration of about 15-50% w/w, more preferably about 20-35% w/w.

The aqueous ammonia is preferably provided as an aqueous solution at a concentration of about 4-28% w/w, more preferably about 8.33% w/w. The ammonium salt and the aqueous ammonia are mixed at a molar ratio from about 1:10 to 10:1, more preferably about 1:3 to 3:1, more preferably a ratio of about 1:3, 1:2, 1:1, 2:1 or 3:1. The solution of aqueous ammonia and the solution of the ammonium salt are preferably equimolar, such that the molar ratio is equal to the volumetric ratio.

Due to the added aqueous ammonia, the total molar amount of ammonia and ammonium is in excess relative to the molar amount of the anion of the ammonium salt. When the anion is a multivalent ion, such as sulfate with a valence of 2 or phosphate with a valence of 3, the molar amount of ammonium from the ammonium salt is double or triple the molar amount of the anion. Therefore, the excess ammonia/ammonium is measured relative to an equivalent molar amount of the anion, which equivalent molar amount is equal to the molar amount of the anion multiplied by the valence of the anion. In one embodiment, the molar amount of ammonia/ammonium is in about 10% excess relative to the equivalent molar amount of the anion of the ammonium salt. In other embodiments, the molar amount of ammonia/ammonium is in about 20%, about 25%, about 33%, about 50%, about 100%, about 200%, about 300% or about 1000% excess relative to the equivalent molar amount of the anion of the ammonium salt.

Sodium bicarbonate is preferably added as a solid to the mixture of the ammonium salt and the aqueous ammonia. The concentration of the sodium bicarbonate in the composition is preferably from 0.2-10% w/v, more preferably about 1-5% w/v, most preferably about 2% w/v or about 2.7% w/v.

The term “about” when preceding a numerical value throughout this specification refers to a range that is 10% more or less than the value.

The composition of the present invention is useful for preparing a halogenated amine biocide. The biocide is preferably prepared by mixing the ammonium salt composition with a hypochlorite oxidant. Preferably, the reaction resulting from the mixing produces monochloramine.

In one embodiment, the biocide is produced in a batch process. The batch process comprises adding a pre-diluted solution of a hypochlorite oxidant in portions to the composition of the present invention while mixing. A control parameter may be monitored during the mixing. In some embodiments, the control parameter is pH and a local maximum in the pH indicates that all of the ammonia and ammonium have reacted, and further addition of hypochlorite will cause degradation of the biocide. In other embodiments, the control parameter is oxidation-reduction potential (ORP) or conductivity, and a local minimum in the ORP or conductivity indicates that all of the ammonia and ammonium have reacted. When the composition comprises ammonium carbamate and is initially diluted in sodium hypochlorite, the conductivity reaches a maximum following the minimum before the monochloramine degrades. In a still further embodiment, the control parameter is dissolved oxygen saturation, which maintains an approximately steady value throughout the reaction between ammonia/ammonium and hypochlorite, and begins to decrease once the ammonia/ammonium is exhausted.

In the present invention, wherein the composition reacting with hypochlorite contains a mixture of an ammonium salt derived from a strong acid, such as ammonium bromide, ammonium chloride or ammonium sulfate, and aqueous ammonia, the starting pH of the composition is higher than that of a composition lacking aqueous ammonia. Therefore, the change in pH, and thus the pH maximum, may be difficult to observe. It should be noted that while the composition comprising ammonium carbamate and aqueous ammonia has a pH in solution that is higher than a solution of ammonium carbamate alone, the pH of the composition is lower than the pH of the presently commercially available formulation of ammonium carbamate which comprises 8% sodium hydroxide.

Furthermore, the starting conductivity of the composition of the invention is lower than that of a composition lacking aqueous ammonia. Therefore, the conductivity minimum may be difficult to observe as the content of ammonia in the composition increases. The ORP exhibits a minimum, but the minimum is much less sharp than that of a solution lacking aqueous ammonia. In such circumstances, it is possible to observe the endpoint more easily using the ratio of ORP/pH. Since the ORP generally decreases as the pH increases, the ratio of ORP/pH has a more observable minimum and can be used as a control parameter. In addition, since ORP takes longer to achieve a stable reading than pH, using the ratio improves accuracy, in particular when producing the biocide in a continuous process. Preferably, the biocide is produced on site and used immediately upon production.

In an alternative embodiment, the biocide is produced in a continuous process. In the continuous process, a solution of hypochlorite and a solution of the composition of the present invention are mixed continuously in a mixer, and the control parameter is monitored online in the mixer or in a conduit downstream from the mixer or is measured in discrete samples removed from the mixer. The flow rate of one of the solutions is held constant while the flow rate of the other solution is varied so as to change the ammonia/ammonium to hypochlorite ratio until the control parameter indicates that the ideal ratio has been achieved. The biocide produced in the continuous process is preferably applied to a medium as it is produced.

The hypochlorite oxidant can be any hypochlorite oxidant, such as the hypochlorite salt of an alkali metal or alkaline carth metal. Preferably, the hypochlorite salt is sodium hypochlorite, potassium hypochlorite or calcium hypochlorite. Most preferably, the hypochlorite salt is sodium hypochlorite.

The hypochlorite solution is preferably prepared by mixing a concentrated stock solution of hypochlorite with water to form a hypochlorite dilution. The concentration of the hypochlorite dilution is preferably from about 1000 to about 20,000 ppm. More preferably, the concentration of the hypochlorite solution is from about 3000 to about 10,000 ppm. Most preferably, the concentration of the hypochlorite solution is from about 3500 to about 7000 ppm. The hypochlorite solution is preferably prepared by diluting a stock solution of about 8-18% w/w with water immediately prior to use. When the biocide is formed in a continuous process, the hypochlorite dilution is preferably prepared online as it is needed.

The composition of the invention is preferably diluted prior to mixing with hypochlorite. In one embodiment, the composition is diluted in water to an ammonia/ammonium concentration of about 1,000 to about 50,000 ppm, more preferably, about 3500 to about 10,000 ppm. Most preferably, the composition is diluted such that equal volumes of the ammonia/ammonium composition and the hypochlorite dilution provide an equimolar mixture of ammonia/ammonium and hypochlorite. In an alternative embodiment, the composition is diluted with the dilute hypochlorite solution. This embodiment is particularly suitable for compositions comprising ammonium carbamate. However, unlike previously known compositions of ammonium carbamate, the present composition comprising ammonium carbamate and aqueous ammonia can be diluted in water. Preferably, the diluted composition is prepared immediately before use. When the biocide is formed in a continuous process, the diluted composition is preferably prepared online as it is needed.

### EXAMPLES

### General Methods

A stock solution (about 12.5% as Cl₂) of sodium hypochlorite was diluted in DI water to a concentration of about 6000 to about 10,000 ppm (as Cl₂). An aqueous ammonia stock solution of about 5-10% w/w was prepared from a commercially available solution of 20-28% w/w. Ammonium salt compositions were prepared by mixing a stock solution of the ammonium salt (20-35%) with the stock solution of aqueous ammonia. A volume of the composition was added to 50 mL deionized (DI) water to achieve a concentration equimolar to about 5000 to about 10,000 ppm hypochlorite (as Cl₂). In the case of ammonium carbamate as the ammonium salt, 2.3 mL of the ammonium salt composition may be diluted in 30 mL diluted hypochlorite solution.

The diluted hypochlorite solution was titrated into the ammonium salt solution while measuring pH, ORP, conductivity and dissolved oxygen. In each example, the volume of hypochlorite found to be the correct volume for the sample with no aqueous ammonia was used for all of the samples. When forming the biocide by titrating hypochlorite into the ammonia/ammonium, the biocide concentration is equal to the concentration of the added hypochlorite and changes throughout the titration as a function of the added hypochlorite volume. Therefore, using the same volume of hypochlorite for each sample ensures a constant concentration of biocide. This is confirmed by a constant chlorine residual at time 0. Absence of biocide degradation was confirmed by the dissolved oxygen measurement. The biocide was then diluted ten-fold and then further diluted to its final concentration.

E. Coli and Bacillus were grown in LB medium, washed with phosphate buffered saline (PBS), and concentrated to about 2×10⁷-2×10⁸ cfu/mL in 40 mL PBS. Glucose (about 5%) was added to the washed samples in some of the tests in order to ensure scavenging of residual free chlorine if the biocide is partially degraded, and in order to simulate real life conditions with microorganisms growing in the presence of food while biocide was added. Tests were also conducted with a mixed microbial population grown from waste water samples.

A portion of the diluted biocide was added to the bacteria at a final concentration of 0.4-1.5 ppm (as Cl₂). Residual chlorine was measured in DI water at the beginning of each test, and in the test solutions after the microorganisms were plated after about 60 minutes. Samples were shaken at 25° C. for 60 minutes and then deactivated with 50 μL sodium thiosulfate (2%). The samples were serially diluted ten-fold about 5 or 6 times, plated with LB agar, and incubated at 37° C. for 48 hours.

### Example 1

Stock solutions 1-5 were prepared by mixing different volumes of ammonium bromide (35% w/w solution) and aqueous ammonia (8.33% w/w solution) as set forth in Table 1. The pH of each solution was measured. A biocide was prepared as described in the general methods above and fed to a sample of Bacillus at a final concentration of 0.5 ppm (as Cl₂). The chlorine residuals and the viable count after biocide treatment are set forth in Table 2.

The results show that as the portion of ammonium bromide decreases, the efficacy of the biocide also decreases. The highest efficacy was found for the neat ammonium bromide without aqueous ammonia, despite the lower chlorine residual.

TABLE 1

| Solution | NH₄Br 35%, mL | NH₃ (aq) 8.33%, mL | pH |
|---|---|---|---|
| 1 | 50 | 0 | 7.00 |
| 2 | 37.5 | 12.5 | 8.94 |
| 3 | 25 | 25 | 9.39 |
| 4 | 12.5 | 37.5 | 9.84 |
| 5 | 0 | 50 | 11.13 |

TABLE 2

| | Bacillus count, | Residual Cl₂, | Residual Cl₂, |
|---|---|---|---|
| Solution | cfu/mL | t = 0, ppm | t = 60 min, ppm |
| Control | 2.00E+07 | 0 | 0 |
| 1 | 2.30E+03 | 0.37 | 0.35 |
| 2 | 1.10E+05 | 0.45 | 0.42 |
| 3 | 1.50E+05 | 0.46 | 0.44 |
| 4 | 6.00E+05 | 0.45 | 0.47 |
| 5 | 1.85E+06 | 0.46 | 0.44 |

### Example 2

Stock solutions 1-4 were prepared by mixing different volumes of sodium bromide (36.8% w/w solution) with a fixed volume of aqueous ammonia (8.33% w/w solution), completing to a fixed volume with water as set forth in Table 3. The pH of each solution was measured. A biocide was prepared as described in the general methods above and fed to a sample of Bacillus at a final concentration of 1.0 ppm (as Cl₂). The chlorine residuals and the viable count after biocide treatment are set forth in Table 4.

TABLE 3

| Solution | NaBr 36.8%, mL | NH₃ (aq) 8.33%, mL | Water, mL | pH |
|---|---|---|---|---|
| 1 | 50 | 50 | 0 | 11.21 |
| 2 | 37.5 | 50 | 12.5 | 11.20 |
| 3 | 25 | 50 | 25 | 11.20 |
| 4 | 12.5 | 50 | 37.5 | 11.24 |

TABLE 4

| | Bacillus count, | Residual Cl₂, | Residual Cl₂, |
|---|---|---|---|
| Solution | cfu/mL | t = 0, ppm | t = 180 min, ppm |
| Control | 2.00E+07 | 0.00 | 0.00 |
| 1 | 1.70E+03 | 0.84 | 0.82 |
| 2 | 7.10E+03 | 0.82 | 0.79 |
| 3 | 1.25E+04 | 0.86 | 0.83 |
| 4 | 1.30E+04 | 0.83 | 0.83 |

The above results show that as the portion of bromide decreases, the efficacy of the biocide also decreases. This example proves that the drop in efficacy shown in Example 1 is not related to the increase in the formulation pH.

### Example 3

Stock solutions 1-5 were prepared by mixing different volumes of ammonium bromide (35% w/w solution) and ammonium chloride (19.1% w/w solution) as set forth in Table 5. The pH of each solution was measured. A biocide was prepared as described in the general methods above and fed to a sample of Bacillus at a final concentration of 1.0 ppm (as Cl₂). The chlorine residuals and the viable count after biocide treatment are set forth in Table 6.

The results show that as the portion of ammonium bromide decreases, the efficacy of the biocide also decreases. As all of the samples have a similar low pH, the reduction in activity cannot be attributed to a change in pH.

TABLE 5

| Solution | NH₄Br 35%, mL | NH₄Cl 19.1%, mL | pH |
|---|---|---|---|
| 1 | 50 | 0 | 5.56 |
| 2 | 37.5 | 12.5 | 5.34 |
| 3 | 25 | 25 | 5.35 |
| 4 | 12.5 | 37.5 | 5.58 |
| 5 | 0 | 50 | 5.51 |

TABLE 6

| | Bacillus count, | Residual Cl₂, | Residual Cl₂, |
|---|---|---|---|
| Solution | cfu/mL | t = 0, ppm | t = 60 min, ppm |
| Control | 1.65E+07 | 0 | 0 |
| 1 | 2.60E+03 | 0.81 | 0.80 |
| 2 | 3.50E+04 | 0.84 | 0.79 |
| 3 | 4.00E+04 | 0.84 | 0.83 |
| 4 | 4.50E+04 | 0.84 | 0.86 |
| 5 | 2.00E+05 | 0.88 | 0.87 |

### Example 4

Stock solutions 1-4 were prepared by mixing different volumes of ammonium carbamate (20% w/w solution) and aqueous ammonia (4.8% w/w solution) as set forth in Table 7. The pH and conductivity of each solution were measured. A biocide was prepared as described in the general methods above and fed to a sample of Bacillus at a final concentration of 0.8 ppm (as Cl₂). The Bacillus samples contained 5% glucose. The chlorine residuals and the viable count after biocide treatment are set forth in Table 8.

TABLE 7

| | NH₄Carbam | NH₃(aq) | | Conductivity, |
|---|---|---|---|---|
| Solution | 20%, mL | 4.8%, mL | pH | mS/cm |
| 1 | 50 | 0 | 9.44 | 137 |
| 2 | 37.5 | 12.5 | 9.82 | 116 |
| 3 | 25 | 25 | 10.08 | 87.5 |
| 4 | 12.5 | 37.5 | 10.36 | 51 |

TABLE 8

| | Bacillus count, | Residual Cl₂, | Residual Cl₂, |
|---|---|---|---|
| Solution | cfu/mL | t = 0, ppm | t = 60 min, ppm |
| Control | 2.70E+08 | 0.74 | 0.25 |
| 1 | 1.30E+06 | 0.73 | 0.29 |
| 2 | 2.70E+06 | 0.73 | 0.31 |
| 3 | 3.80E+06 | 0.72 | 0.25 |
| 4 | 6.50E+06 | 0.67 | 0.29 |

The above results show that as the portion of ammonium carbamate decreases, the efficacy of the biocide also decreases. In the presence of glucose, the chlorine demand is significantly higher. There is no direct interaction between the biocide and glucose. The high demand results from intensive microbial activity in the presence of glucose. The glucose thus makes the culture more resistant to biocides and bears a higher resemblance to real life activity.

### Example 5

Stock solutions 1-5 were prepared by mixing different volumes of ammonium bromide (35% w/w solution) and aqueous ammonia (8.33% w/w solution) as set forth in Table 9. Sodium bicarbonate was added to each stock solution at a concentration of 2.7% w/v. The pH of each solution was measured. A biocide was prepared as described in the general methods above and fed to a sample of Bacillus at a final concentration of 1.0 ppm (as Cl₂). The Bacillus samples contained 5% glucose. The chlorine residuals and the viable count after biocide treatment are set forth in Table 10.

TABLE 9

| Solution | NH₄Br 35%, mL | NH₃ (aq) 8.33%, mL | pH |
|---|---|---|---|
| 1 | 50 | 0 | 7.20 |
| 2 | 37.5 | 12.5 | 9.00 |
| 3 | 25 | 25 | 9.49 |
| 4 | 12.5 | 37.5 | |
| 5 | 0 | 50 | 10.70 |

TABLE 10

| | Bacillus count, | Residual Cl₂, | Residual Cl₂, |
|---|---|---|---|
| Solution | cfu/mL | t = 0, ppm | t = 60 min, ppm |
| Control | 8.00E+07 | 0 | 0 |
| 1 | 1.70E+03 | 0.84 | 0.44 |
| 2 | 1.48E+03 | 0.90 | 0.40 |
| 3 | 1.36E+03 | 0.90 | 0.49 |
| 4 | 1.70E+03 | 0.90 | 0.49 |
| 5 | 1.46E+03 | 0.91 | 0.48 |

The above results show that a small amount of sodium bicarbonate added to the ammonium salt mitigates the effects of removing bromide demonstrated in Example 1 above.

### Example 6

Stock solutions 1-6 were prepared by mixing different volumes of ammonium bromide (35% w/w solution) and aqueous ammonia (8.33% w/w solution) as set forth in Table 11. Sodium bicarbonate was added to solutions 2-6 at a concentration of 2.7%. The pH of each solution was measured. A biocide was prepared as described in the general methods above and fed to a sample of E. coli at a final concentration of 1.0 ppm (as Cl₂). The E. coli samples contained 5% glucose. The chlorine residuals and the viable count after biocide treatment are set forth in Table 12.

TABLE 11

| Solution | NH₄Br 35%, mL | NH₃ (aq) 8.33%, mL | pH |
|---|---|---|---|
| 1 | 50 | 0 | 5.48 |
| 2 | 50 | 0 | 7.58 |
| 3 | 37.5 | 12.5 | 9.00 |
| 4 | 25 | 25 | 9.52 |
| 5 | 12.5 | 37.5 | 9.99 |
| 6 | 0 | 50 | 10.90 |

TABLE 12

| | E. coli count, | Residual Cl₂, | Residual Cl₂, |
|---|---|---|---|
| Solution | cfu/mL | t = 0, ppm | t = 60 min, ppm |
| Control | 2.40E+08 | 0 | 0 |
| 1 | 2.00E+03 | 1.01 | 0.62 |
| 2 | 3.20E+03 | 0.99 | 0.61 |
| 3 | 3.60E+03 | 1.01 | 0.72 |
| 4 | 1.60E+03 | 1.00 | 0.65 |
| 5 | 5.60E+03 | 1.00 | 0.66 |
| 6 | 8.00E+03 | 0.96 | 0.69 |

The above results show that a small amount of sodium bicarbonate added to the ammonium salt mitigates the effects of removing bromide demonstrated in Example 1 above. The sample with a 1:1 mixture of ammonium bromide and aqueous ammonia performed better than the sample of pure ammonium bromide without sodium bicarbonate.

### Example 7

Stock solutions 1-6 were prepared by mixing different amounts of sodium bicarbonate into a mixture of equal volumes of ammonium bromide (35% w/w solution) and aqueous ammonia (8.33% w/w solution) as set forth in Table 13. The pH and conductivity of each solution was measured. A biocide was prepared as described in the general methods above and fed to a sample of E. coli at a final concentration of 1.0 ppm (as Cl₂). The E. coli samples contained 5% glucose. The chlorine residuals and the viable count after biocide treatment are set forth in Table 14.

TABLE 13

| Solution | NaHCO₃, % w/v | pH | Conductivity, mS/cm |
|---|---|---|---|
| 1 | 0 | 9.43 | 226 |
| 2 | 0.2 | 9.43 | 229 |
| 3 | 1 | 9.40 | 231 |
| 4 | 2 | 9.38 | 231 |
| 5 | 5 | 9.34 | 231 |
| 6 | 10 | 9.24 | 227 |

TABLE 14

| | E. coli count, | Residual Cl₂, | Residual Cl₂, |
|---|---|---|---|
| Solution | cfu/mL | t = 0, ppm | t = 60 min, ppm |
| Control | 4.00E+08 | 0 | 0 |
| 1 | 3.20E+05 | 0.93 | 0.12 |
| 2 | 1.60E++05 | 0.86 | 0.19 |
| 3 | 9.50E+04 | 0.86 | 0.26 |
| 4 | 2.65E+04 | 0.90 | 0.27 |
| 5 | 6.00E+04 | 0.87 | 0.29 |
| 6 | 5.50E+05 | 0.77 | 0.26 |

As the buffer effect of the sodium bicarbonate increases, the pH of the mixture is slightly lower, but overall the effect on the pH of the ammonium bromide/aqueous ammonia mixture is minimal. There is also no substantial effect on the conductivity of the formulated mixture. The increase in efficacy is related to the concentration of sodium bicarbonate, the best result being achieved at a feed rate of 2% w/v sodium bicarbonate in the ammonium bromide/aqueous ammonia composition. At higher concentrations of sodium bicarbonate, the efficacy decreased.

### Example 8

Stock solutions 1-5 were prepared by mixing different volumes of ammonium chloride (19.1% w/w solution) and aqueous ammonia (8.33% w/w solution) as set forth in Table 15. Sodium bicarbonate was added to solutions 2-5 at a concentration of 2.7% w/v. The pH and conductivity of each solution were measured. A biocide was prepared as described in the general methods above and fed to a sample of a mixture of microorganisms (MO) isolated from domestic effluent at a final concentration of 1.5 ppm (as Cl₂). The chlorine residuals and the viable count after biocide treatment are set forth in Table 16.

The results show that a small amount of sodium bicarbonate added to the ammonium salt improves the biocidal activity. The sample with a 1:1 mixture of ammonium chloride and aqueous ammonia performed as well as the sample of pure ammonium chloride without sodium bicarbonate and the sample with a 3:1 mixture of ammonium chloride and aqueous ammonia performed even better.

TABLE 15

| | NH₄Cl | NH₃ (aq) | | Cond., |
|---|---|---|---|---|
| Solution | 19.1%, mL | 8.33%, mL | pH | mS/cm |
| 1 | 50 | 0 | 4.41 | 371 |
| 2 | 50 | 0 | 6.98 | 357 |
| 3 | 37.5 | 12.5 | 9.00 | 279 |
| 4 | 25 | 25 | 9.59 | 194 |
| 5 | 12.5 | 37.5 | 10.09 | 110 |

TABLE 16

| | MO count, | Residual Cl₂, | Residual Cl₂, |
|---|---|---|---|
| Solution | cfu/mL | t = 0, ppm | t = 60 min, ppm |
| Control | 1.80E+08 | 0 | 0 |
| 1 | 1.30E+02 | 1.47 | 1.13 |
| 2 | 1.70E+02 | 1.47 | 1.14 |
| 3 | 4.00E+01 | 1.46 | 1.18 |
| 4 | 1.30E+02 | 1.48 | 1.19 |
| 5 | 2.30E+02 | 1.51 | 1.14 |

### Example 9

Stock solutions 1-6 were prepared by mixing different volumes of ammonium carbamate (20% w/w solution) and aqueous ammonia (8.33% w/w solution) as set forth in Table 17. Sodium bicarbonate was added to solutions 2-6 at a concentration of 2.7% w/v. The pH and conductivity of each solution were measured. A biocide was prepared as described in the general methods above and fed to a sample of a mixture of microorganisms (MO) isolated from domestic effluent at a final concentration of 1.5 ppm (as Cl₂). The chlorine residuals and the viable count after biocide treatment are set forth in Table 18.

The results show that a small amount of sodium bicarbonate added to the ammonium salt mitigates the effects of removing carbamate demonstrated in Example 4 above. The sample with a 1:1 mixture of ammonium carbamate and ammonium hydroxide performed best.

TABLE 17

| | NH₄Carbam | NH₃ (aq) | | Cond., |
|---|---|---|---|---|
| Solution | 20%, mL | 8.33%, mL | pH | mS/cm |
| 1 | 50 | 0 | 9.46 | 149 |
| 2 | 50 | 0 | 9.35 | 152 |
| 3 | 37.5 | 12.5 | 9.71 | 131 |
| 4 | 25 | 25 | 10.02 | 103 |
| 5 | 12.5 | 37.5 | 10.35 | 68 |
| 6 | 0 | 50 | 11.03 | 28 |

TABLE 18

| | MO count, | Residual Cl₂, | Residual Cl₂, |
|---|---|---|---|
| Solution | cfu/mL | t = 0, ppm | t = 60 min, ppm |
| Control | 1.97E+08 | 0 | 0 |
| 1 | 2.00E+06 | 1.52 | 0.28 |
| 2 | 2.10E+06 | 1.49 | 0.29 |
| 3 | 2.12E+06 | 1.47 | 0.32 |
| 4 | 1.70E+05 | 1.5 | 0.35 |
| 5 | 1.80E+06 | 1.47 | 0.40 |
| 6 | 2.00E+06 | 1.44 | 0.38 |

### Example 10

Stock solutions 1-6 were prepared by mixing different amounts of sodium bicarbonate into aqueous ammonia (8.33% w/w solution) as set forth in Table 19. The pH and conductivity of each solution was measured. A biocide was prepared as described in the general methods above and fed to a mixed culture sample at a final concentration of 1.0 ppm (as Cl₂). The mixed culture samples contained 5% glucose. The chlorine residuals and the viable count after biocide treatment are set forth in Table 20.

This option is not realistic as a field application for industrial uses due to the properties of aqueous ammonia but it is an interesting theoretical example. The effect of increasing concentration of sodium bicarbonate on the pH and conductivity of the formulation is clear. Overall efficacy exhibited by aqueous ammonia alone is not very high, however the effect of addition of sodium bicarbonate is clear, and is similar to the trends observed with ammonium salts.

TABLE 19

| Solution | NaHCO₃, % w/v | pH | Conductivity, mS/cm |
|---|---|---|---|
| 1 | 0 | 12.33 | 0.17 |
| 2 | 0.5 | 11.47 | 15.6 |
| 3 | 1 | 11.29 | 28.2 |
| 4 | 1.5 | 11.16 | 39.8 |
| 5 | 3 | 10.97 | 70.2 |
| 6 | 5 | 10.84 | 90.2 |

TABLE 20

| | E. coli count, | Residual Cl₂, | Residual Cl₂, |
|---|---|---|---|
| Solution | cfu/mL | t = 0, ppm | t = 60 min, ppm |
| Control | 1.60E+08 | 0 | 0 |
| 1 | 1.00E+06 | 1.00 | 0.59 |
| 2 | 1.00E+06 | 1.00 | 0.60 |
| 3 | 8.50E+05 | 0.98 | 0.61 |
| 4 | 6.00E+05 | 0.95 | 0.65 |
| 5 | 6.10E+05 | 0.95 | 0.61 |
| 6 | 5.50E+06 | 0.84 | 0.54 |

### Example 11

Stock solutions 1-5 were prepared by mixing different volumes of ammonium carbamate (20% w/w solution) and aqueous ammonia (8.33% w/w solution) as set forth in Table 21. 2.3 mL of each sample was diluted in 30 mL of a 5000 ppm (as Cl₂) sodium hypochlorite solution. Additional sodium hypochlorite was added while measuring the pH, conductivity and ORP. An error occurred in the measurement of solution 1.

TABLE 21

| Solution | NH₄Carbam 20%, mL | NH₃(aq) 4.8%, mL |
|---|---|---|
| 1 | 50 | 0 |
| 2 | 37.5 | 12.5 |
| 3 | 25 | 25 |
| 4 | 12.5 | 37.5 |
| 5 | 0 | 50 |

Table 22 shows the results of the conductivity measurements. Conductivity is expected to have a minimum followed by a maximum. The conductivity maximum of each solution is in bold. As the amount of aqueous ammonia increases, the changes in conductivity are smaller, and the maximum value appears earlier. Thus, conductivity becomes an unviable control parameter.

TABLE 22

| | |
|---|---|
| Volume of | Conductivity, mS/cm |

| NaOCl, mL | 1 | 2 | 3 | 4 | 5 |
|---|---|---|---|---|---|
| 30 | 29.3 | 26.2 | 21 | 21 | 20.5 |
| 40 | 29.6 | 23.3 | 19.32 | 19.36 | 28.8 |
| 50 | 29.9 | 21.4 | 18.43 | 21.9 | 29.6 |
| 60 | 30.1 | 19.81 | 19.06 | 23.6 | 29.9 |
| 70 | 29.8 | 18.61 | 20.6 | 24.9 | 30.1 |
| 80 | 29.3 | 18.8 | 21.8 | 25.8 | 30.2 |
| 90 | 28.6 | 18.48 | 22.8 | 26.4 | 30.4 |
| 100 | 27.8 | 18.34 | 23.5 | 27 | 30.5 |
| 110 | | 18.33 | 24.2 | 27.8 | 30.4 |
| 120 | | 18.58 | 24.7 | 27.4 | 30.3 |
| 130 | | 19.12 | 24.7 | 27.5 | 30 |
| 140 | | 19.29 | 24.4 | 27.5 | 29.7 |
| 150 | | 19.15 | 24 | 27.0 | 29.1 |

Table 23 shows the results of the pH measurements. The pH maximum of each solution is in bold. While a maximum was observed for each solution, as the amount of aqueous ammonia increases, the pH maximum becomes less sharp and harder to observe, making it an unviable control parameter. Furthermore, it can be seen that the maximum was not observed at a consistent volume of hypochlorite added.

TABLE 23

| | |
|---|---|
| Volume of | pH |

| NaOCl, mL | 1 | 2 | 3 | 4 | 5 |
|---|---|---|---|---|---|
| 30 | 12.23 | 9.53 | 9.90 | 10.34 | 12.14 |
| 40 | 12.40 | 9.54 | 9.84 | 10.54 | 12.40 |
| 50 | 12.49 | 9.62 | 10.08 | 11.18 | 12.50 |
| 60 | 12.53 | 9.71 | 10.23 | 12.00 | 12.56 |
| 70 | 12.57 | 9.84 | 10.57 | 12.25 | 12.59 |
| 80 | 12.58 | 9.99 | 11.36 | 12.38 | 12.62 |
| 90 | 12.57 | 10.18 | 11.93 | 12.44 | 12.64 |
| 100 | 12.54 | 10.41 | 12.12 | 12.50 | 12.65 |
| 110 | | 10.74 | 12.24 | 12.53 | 12.66 |
| 120 | | 11.28 | 12.30 | 12.54 | 12.67 |
| 130 | | 11.60 | 12.31 | 12.54 | 12.66 |
| 140 | | 11.61 | 12.29 | 12.52 | 12.65 |
| 150 | | 11.40 | 12.26 | 12.50 | 12.61 |

Table 24 shows the results of the ORP measurements. The ORP minimum of each solution is in bold. While a minimum was observed for each solution, as the amount of aqueous ammonia increases, the ORP minimum becomes less sharp and harder to observe. Furthermore, measuring ORP accurately requires some equilibration time after hypochlorite is added to the ammonium salt formulation. In the lab setting described here, such equilibration time is available. However, in the field when using a continuous process for producing the biocide, such as that described in U.S. Pat. No. 9,801,384, there is no time for equilibration. Thus, the small differences in ORP for biocides made using aqueous ammonia may be difficult to observe.

TABLE 24

| | |
|---|---|
| Volume of | ORP, mV |

| NaOCl, mL | 1 | 2 | 3 | 4 | 5 |
|---|---|---|---|---|---|
| 30 | 276 | 425 | 400 | 363 | 228 |
| 40 | 270 | 428 | 393 | 348 | 244 |
| 50 | 277 | 416 | 389 | 312 | 240 |
| 60 | 274 | 414 | 383 | 278 | 253 |
| 70 | 272 | 409 | 368 | 279 | 256 |
| 80 | 270 | 404 | 336 | 276 | 260 |
| 90 | 265 | 395 | 301 | 273 | 264 |
| 100 | 263 | 386 | 290 | 276 | 264 |
| 110 | | 370 | 283 | 269 | 260 |
| 120 | | 340 | 276 | 264 | 254 |
| 130 | | 304 | 272 | 262 | 254 |
| 140 | | 320 | 277 | 266 | 250 |
| 150 | | 370 | 279 | 270 | 261 |

Table 25 displays a new parameter, the ratio of ORP/pH. This parameter has a minimum value which was found to be consistent and observable for all samples. Therefore, this is a useful parameter for controlling the production of a biocide, even under conditions where pH or ORP alone cannot be used. Since, in general, prior to the reaction endpoint, ORP is decreasing and pH is increasing, using the ratio ORP/pH amplifies the changes in the individual parameters and makes the endpoint easier to observe.

TABLE 25

| | |
|---|---|
| Volume of | ORP/pH, mV |

| NaOCl, mL | 1 | 2 | 3 | 4 | 5 |
|---|---|---|---|---|---|
| 30 | 22.60 | 44.61 | 40.42 | 35.13 | 18.79 |
| 40 | 21.78 | 44.85 | 39.94 | 33.02 | 19.69 |
| 50 | 22.21 | 43.20 | 38.61 | 27.92 | 19.19 |
| 60 | 21.83 | 42.62 | 37.45 | 23.17 | 20.15 |
| 70 | 21.61 | 41.57 | 34.81 | 22.78 | 20.33 |
| 80 | 21.47 | 40.46 | 29.61 | 22.30 | 20.59 |
| 90 | 21.07 | 38.82 | 25.23 | 21.95 | 20.88 |
| 100 | 21.00 | 37.08 | 23.93 | 22.08 | 20.87 |
| 110 | | 34.45 | 23.12 | 21.44 | 20.52 |
| 120 | | 30.14 | 22.42 | 21.03 | 20.05 |
| 130 | | 26.16 | 22.07 | 20.87 | 20.06 |
| 140 | | 27.59 | 22.50 | 21.25 | 19.77 |
| 150 | | 32.47 | 22.76 | 21.62 | 20.67 |

### Example 12

Stock solutions 1-6 were prepared by mixing different volumes of ammonium carbamate (20% w/w solution) and aqueous ammonia (8.33% w/w solution) as set forth in Table 26. Sodium bicarbonate was added to solutions 2-6 at a concentration of 2.7% w/v. A sample of each solution was diluted in 50 mL of DI water and sodium hypochlorite was added while measuring the pH, conductivity and ORP. Conductivity was found not to be a useful parameter for control.

TABLE 26

| Solution | NH₄Carbam 20%, mL | NH₃(aq) 8.33%, mL |
|---|---|---|
| 1 | 50 | 0 |
| 2 | 50 | 0 |
| 3 | 37.5 | 12.5 |
| 4 | 25 | 25 |
| 5 | 12.5 | 37.5 |
| 6 | 0 | 50 |

Table 27 shows the results of the pH measurements. The pH maximum of each solution is in bold. While a maximum was observed for each solution, as the amount of aqueous ammonia increases, the pH maximum becomes less sharp and harder to observe, making it an unviable control parameter. Furthermore, it can be seen that the maximum was not observed at a consistent volume of hypochlorite added.

TABLE 27

| Volume of | pH | | | | | |
|---|---|---|---|---|---|---|
| NaOCl, mL | 1 | 2 | 3 | 4 | 5 | 6 |
| 0 | 9.24 | 9.20 | 9.41 | 9.70 | 10.07 | 10.80 |
| 10 | 9.33 | 9.30 | 9.53 | 9.85 | 10.46 | 11.99 |
| 20 | 9.46 | 9.43 | 9.72 | 10.20 | 11.66 | 12.26 |
| 30 | 9.62 | 9.60 | 9.96 | 10.93 | 12.08 | 12.37 |
| 40 | 9.83 | 9.80 | 10.33 | 11.81 | 12.25 | 12.42 |
| 50 | 10.09 | 10.05 | 11.05 | 12.08 | 12.33 | 12.46 |
| 60 | 10.45 | 10.36 | 11.75 | 12.20 | 12.38 | 12.50 |
| 70 | 11.12 | 10.86 | 11.94 | 12.21 | 12.37 | 12.49 |
| 80 | 11.57 | 11.24 | 11.92 | 12.19 | 12.35 | 12.46 |
| 90 | 11.52 | 11.11 | 11.88 | 12.16 | 12.31 | 12.42 |
| 100 | 11.30 | 10.00 | 11.81 | 12.10 | 12.28 | 12.39 |
| 110 | 9.30 | | 11.68 | 12.04 | 12.19 | 12.32 |

Table 28 shows the results of the ORP measurements. The ORP minimum of each solution is in bold. While a minimum was observed for each solution, as the amount of aqueous ammonia increases, the ORP minimum becomes less sharp and harder to observe.

Table 29 displays a new parameter, the ratio of ORP/pH. This parameter has a minimum value which was found to be consistent and observable for all samples. Therefore, this is a useful parameter for controlling the production of a biocide, even under conditions where pH or ORP alone cannot be used. Since, in general, prior to the reaction endpoint, ORP is decreasing and pH is increasing, using the ratio ORP/pH amplifies the changes in the individual parameters and makes the endpoint easier to observe.

A further important result to be noted is that while using a previously known solution of ammonium carbamate containing 8% NaOH, a biocide could only be prepared by diluting the carbamate solution in a dilute hypochlorite solution, when using the present composition, a biocide can also be prepared by diluting the composition in water.

TABLE 28

| Volume of | ORP, mV | | | | | |
|---|---|---|---|---|---|---|
| NaOCl, mL | 1 | 2 | 3 | 4 | 5 | 6 |
| 0 | 209 | 277 | 213 | 189 | 105 | 70 |
| 10 | 430 | 430 | 412 | 385 | 348 | 273 |
| 20 | 433 | 430 | 421 | 393 | 310 | 285 |
| 30 | 436 | 428 | 414 | 365 | 296 | 282 |
| 40 | 424 | 422 | 400 | 320 | 292 | 283 |
| 50 | 412 | 413 | 360 | 307 | 284 | 280 |
| 60 | 396 | 393 | 322 | 292 | 280 | 277 |
| 70 | 362 | 366 | 300 | 285 | 280 | 272 |
| 80 | 319 | 343 | 312 | 290 | 288 | 279 |
| 90 | 339 | 380 | 320 | 300 | 295 | 287 |
| 100 | 380 | 480 | 335 | 312 | 303 | 293 |
| 110 | 423 | | 353 | 321 | 312 | 305 |

TABLE 29

| Volume of | ORP/pH, mV | | | | | |
|---|---|---|---|---|---|---|
| NaOCl, mL | 1 | 2 | 3 | 4 | 5 | 6 |
| 0 | 22.61 | 30.13 | 22.60 | 19.52 | 10.44 | 6.44 |
| 10 | 46.09 | 46.26 | 43.23 | 39.09 | 33.27 | 22.78 |
| 20 | 45.77 | 45.60 | 43.31 | 38.53 | 26.59 | 23.25 |
| 30 | 45.32 | 44.58 | 41.57 | 33.43 | 24.50 | 22.80 |
| 40 | 43.15 | 43.06 | 38.72 | 27.10 | 23.84 | 22.78 |
| 50 | 40.83 | 41.09 | 32.58 | 25.37 | 23.03 | 22.48 |
| 60 | 37.89 | 37.93 | 27.40 | 23.93 | 22.62 | 22.18 |
| 70 | 32.55 | 33.72 | 25.13 | 23.34 | 22.63 | 21.78 |
| 80 | 27.57 | 30.52 | 26.17 | 23.80 | 23.29 | 22.39 |
| 90 | 29.43 | 34.20 | 26.94 | 24.67 | 23.96 | 23.11 |
| 100 | 33.63 | 48.00 | 28.37 | 25.75 | 24.68 | 23.65 |
| 110 | 45.44 | | 30.22 | 26.63 | 25.63 | 24.76 |

### Example 13

Stock solutions 1-6 were prepared by mixing different volumes of ammonium bromide (35% w/w solution) and aqueous ammonia (8.33% w/w solution) as set forth in Table 30. Sodium bicarbonate was added to solutions 2-6 at a concentration of 2.7% w/v. A sample of each solution was diluted in 50 mL DI water and sodium hypochlorite was added while measuring the pH, conductivity and ORP. Conductivity was found not to be a useful parameter for control.

TABLE 30

| Solution | NH₄Br 35%, mL | NH₃(aq) 8.33%, mL |
|---|---|---|
| 1 | 50 | 0 |
| 2 | 50 | 0 |
| 3 | 37.5 | 12.5 |
| 4 | 25 | 25 |
| 5 | 12.5 | 37.5 |
| 6 | 0 | 50 |

Table 31 shows the results of the pH measurements. The pH maximum of each solution is in bold. While a maximum was observed for each solution, as the amount of aqueous ammonia increases, the pH maximum becomes less sharp and harder to observe, making it an unviable control parameter.

TABLE 31

| Volume of | pH | | | | | |
|---|---|---|---|---|---|---|
| NaOCl, mL | 1 | 2 | 3 | 4 | 5 | 6 |
| 0 | 5.40 | 7.99 | 8.9 | 9.4 | 9.88 | 10.46 |
| 10 | 7.76 | 8.28 | 9.08 | 9.60 | 10.21 | 11.63 |
| 20 | 8.35 | 8.55 | 9.29 | 9.89 | 11.24 | 12.11 |
| 30 | 8.70 | 8.82 | 9.57 | 10.50 | 11.97 | 12.32 |
| 40 | 9.05 | 9.12 | 10.00 | 11.67 | 12.19 | 12.38 |
| 50 | 9.63 | 9.52 | 10.64 | 12.02 | 12.31 | 12.45 |
| 60 | 11.30 | 9.80 | 11.53 | 12.08 | 12.33 | 12.48 |
| 70 | 7.40 | 7.50 | 9.70 | 10.20 | 12.25 | 12.47 |
| 80 | | | 7.50 | 9.00 | 11.85 | 12.44 |
| 90 | | | | 7.00 | 9.20 | 12.42 |
| 100 | | | | | | 12.39 |
| 110 | | | | | | 12.36 |

Table 32 shows the results of the ORP measurements. The ORP minimum of each solution is in bold. While a minimum was observed for each solution, as the amount of aqueous ammonia increases, the ORP minimum becomes less sharp and harder to observe.

TABLE 32

| Volume of | ORP, mV | | | | | |
|---|---|---|---|---|---|---|
| NaOCl, mL | 1 | 2 | 3 | 4 | 5 | 6 |
| 0 | 487 | 325 | 270 | 168 | 170 | 127 |
| 10 | 530 | 507 | 458 | 410 | 377 | 304 |
| 20 | 509 | 498 | 457 | 419 | 345 | 296 |
| 30 | 491 | 485 | 445 | 393 | 309 | 293 |
| 40 | 473 | 469 | 422 | 329 | 300 | 290 |
| 50 | 444 | 451 | 391 | 308 | 292 | 286 |
| 60 | 347 | 439 | 329 | 295 | 286 | 282 |
| 70 | 656 | 621 | 442 | 415 | 289 | 282 |
| 80 | | | 615 | 488 | 330 | 289 |
| 90 | | | | 650 | 510 | 292 |
| 100 | | | | | | 300 |
| 110 | | | | | | 307 |

Table 33 displays a new parameter, the ratio of ORP/pH. This parameter has a minimum value which was found to be consistent and observable for all samples. Therefore, this is a useful parameter for controlling the production of a biocide, even under conditions where pH or ORP alone cannot be used. Since, in general, prior to the reaction endpoint, ORP is decreasing and pH is increasing, using the ratio ORP/pH amplifies the changes in the individual parameters and makes the endpoint easier to observe.

TABLE 33

| Volume of | ORP/pH, mV | | | | | |
|---|---|---|---|---|---|---|
| NaOCl, mL | 1 | 2 | 3 | 4 | 5 | 6 |
| 0 | 90.19 | 40.68 | 40.68 | 17.87 | 17.21 | 12.16 |
| 10 | 68.30 | 61.23 | 61.23 | 42.71 | 36.92 | 26.14 |
| 20 | 60.96 | 58.25 | 58.25 | 42.37 | 30.67 | 24.44 |
| 30 | 56.41 | 54.99 | 54.99 | 37.43 | 25.81 | 23.75 |
| 40 | 52.31 | 51.43 | 51.43 | 28.16 | 24.57 | 23.42 |
| 50 | 46.14 | 47.32 | 47.32 | 25.59 | 23.72 | 22.95 |
| 60 | 30.69 | 44.81 | 44.81 | 24.42 | 23.20 | 22.60 |
| 70 | 88.65 | 82.80 | 82.80 | 40.69 | 23.59 | 22.57 |
| 80 | | | | 54.22 | 27.85 | 23.20 |
| 90 | | | | 92.86 | 55.43 | 23.47 |
| 100 | | | | | | 24.21 |
| 110 | | | | | | 24.84 |

### Example 14

Stock solutions 1-6 were prepared by mixing different volumes of ammonium chloride (19.1% w/w solution) and aqueous ammonia (8.33% w/w solution) as set forth in Table 34. Sodium bicarbonate was added to solutions 2-6 at a concentration of 2.7% w/v. A sample of each solution was diluted in 50 mL DI water and sodium hypochlorite was added while measuring the pH, conductivity and ORP. Conductivity was found not to be a useful parameter for control.

TABLE 34

| Solution | NH₄Cl 19.1%, mL | NH₃(aq) 8.33%, mL |
|---|---|---|
| 1 | 50 | 0 |
| 2 | 50 | 0 |
| 3 | 37.5 | 12.5 |
| 4 | 25 | 25 |
| 5 | 12.5 | 37.5 |
| 6 | 0 | 50 |

Table 35 shows the results of the pH measurements. The pH maximum of each solution is in bold. While a maximum was observed for each solution, as the amount of aqueous ammonia increases, the pH maximum becomes less sharp and harder to observe, making it an unviable control parameter.

Table 36 shows the results of the ORP measurements. The ORP minimum of each solution is in bold. While a minimum was observed for each solution, as the amount of aqueous ammonia increases, the ORP minimum becomes less sharp and harder to observe.

Table 37 displays a new parameter, the ratio of ORP/pH. This parameter has a minimum value which was found to be consistent and observable for all samples. Therefore, this is a useful parameter for controlling the production of a biocide, even under conditions where pH or ORP alone cannot be used. Since, in general, prior to the reaction endpoint, ORP is decreasing and pH is increasing, using the ratio ORP/pH amplifies the changes in the individual parameters and makes the endpoint easier to observe.

TABLE 35

| Volume of | pH | | | | | |
|---|---|---|---|---|---|---|
| NaOCl, mL | 1 | 2 | 3 | 4 | 5 | 6 |
| 0 | 5.30 | 7.33 | 9.00 | 9.51 | 9.94 | 10.76 |
| 10 | 7.93 | 8.00 | 9.15 | 9.67 | 10.36 | 11.94 |
| 20 | 8.32 | 8.36 | 9.35 | 10.02 | 11.66 | 12.24 |
| 30 | 8.68 | 8.68 | 9.66 | 11.17 | 12.10 | 12.36 |
| 40 | 9.04 | 9.05 | 10.34 | 11.94 | 12.27 | 12.43 |
| 50 | 9.95 | 9.62 | 11.67 | 12.16 | 12.36 | 12.48 |
| 60 | 11.58 | 11.20 | 11.95 | 12.24 | 12.39 | 12.50 |
| 70 | 11.67 | 11.30 | 12.00 | 12.25 | 12.41 | 12.50 |
| 80 | 11.62 | 6.50 | 11.98 | 12.22 | 12.37 | 12.48 |
| 90 | 4.500 | | 11.930 | 12.194 | 12.340 | 12.445 |
| 100 | | | 11.850 | 12.140 | 12.300 | 12.425 |
| 110 | | | 11.730 | 12.090 | 12.265 | 12.370 |
| 120 | | | 11.580 | 12.020 | | |

TABLE 36

| Volume of | ORP, mV | | | | | |
|---|---|---|---|---|---|---|
| NaOCl, mL | 1 | 2 | 3 | 4 | 5 | 6 |
| 0 | 465 | 362 | 218 | 208 | 182 | 106 |
| 10 | 535 | 522 | 434 | 400 | 358 | 272 |
| 20 | 515 | 510 | 438 | 404 | 316 | 283 |
| 30 | 497 | 495 | 431 | 352 | 301 | 287 |
| 40 | 476 | 476 | 403 | 313 | 295 | 286 |
| 50 | 432 | 447 | 330 | 303 | 291 | 284 |
| 60 | 327 | 354 | 308 | 292 | 287 | 282 |
| 70 | 337 | 368 | 309 | 291 | 282 | 276 |
| 80 | 353 | 700 | 319 | 300 | 289 | 280 |
| 90 | 752 | | 327 | 307 | 295 | 285 |
| 100 | | | 341 | 314 | 302 | 290 |
| 110 | | | 358 | 323 | 309 | 293 |
| 120 | | | 377 | 332 | | |

TABLE 37

| Volume of | ORP/pH, mV | | | | | |
|---|---|---|---|---|---|---|
| NaOCl, mL | 1 | 2 | 3 | 4 | 5 | 6 |
| 0 | 87.74 | 49.39 | 24.22 | 21.87 | 18.26 | 9.88 |
| 10 | 67.47 | 65.25 | 47.43 | 41.37 | 34.56 | 22.78 |
| 20 | 61.90 | 61.00 | 46.84 | 40.32 | 27.10 | 23.15 |
| 30 | 57.29 | 57.03 | 44.62 | 31.51 | 24.88 | 23.22 |
| 40 | 52.63 | 52.54 | 38.97 | 26.21 | 24.04 | 23.01 |
| 50 | 43.42 | 46.47 | 28.28 | 24.92 | 23.54 | 22.76 |
| 60 | 28.24 | 31.61 | 25.77 | 23.86 | 23.16 | 22.56 |
| 70 | 28.88 | 32.52 | 25.75 | 23.77 | 22.72 | 22.08 |
| 80 | 30.38 | 107.69 | 26.59 | 24.55 | 23.37 | 22.43 |
| 90 | 167.11 | | 27.41 | 25.18 | 23.91 | 22.86 |
| 100 | | | 28.78 | 25.86 | 24.55 | 23.34 |

### Example 15

Stock solutions 1-6 were prepared by mixing different volumes of ammonium carbamate (20% w/w solution) and aqueous ammonia (8.33% w/w solution) as set forth in Table 38. Sodium bicarbonate was added to solutions 2-6 at a concentration of 2.7% w/v. A comparative solution 0 was a formulation of 20% w/w ammonium carbamate including 8% w/w NaOH. The pH and conductivity of each solution were measured. A biocide was prepared as described in the general methods above and fed to a sample of E. coli at a final concentration of 0.5 ppm (as Cl₂). The chlorine residuals and the viable count after biocide treatment are set forth in Table 39.

TABLE 38

| | NH₄Carbam | NH₃ (aq) | | Cond., |
|---|---|---|---|---|
| Solution | 20%, mL | 8.33%, mL | pH | mS/cm |
| 0 | | | 10.45 | 106 |
| 1 | 50 | 0 | 9.51 | 148 |
| 2 | 50 | 0 | 9.38 | 150 |
| 3 | 37.5 | 12.5 | 9.76 | 129 |
| 4 | 25 | 25 | 10.06 | 101 |
| 5 | 12.5 | 37.5 | 10.37 | 67 |
| 6 | 0 | 50 | 11.03 | 28 |

TABLE 39

| | MO count, | Residual Cl₂, | Residual Cl₂, |
|---|---|---|---|
| Solution | cfu/mL | t = 0, ppm | t = 60 min, ppm |
| Control | 5.00E+07 | 0 | 0 |
| 0 | 1.90E+04 | 0.88 | 0.29 |
| 1 | 1.13E+04 | 0.94 | 0.37 |
| 2 | 6.00E+03 | 0.88 | 0.38 |
| 3 | 1.00E+04 | 0.90 | 0.37 |
| 4 | 1.10E+04 | 0.94 | 0.41 |
| 5 | 1.12E+04 | 0.92 | 0.41 |
| 6 | 2.25E+03 | 0.96 | 0.41 |

These results show that the efficacy of biocides formed from the composition comprising ammonium carbamate, aqueous ammonia and sodium bicarbonate is at least as good as the formulation comprising ammonium carbamate and sodium hydroxide. The composition of the present application is advantageous in that the lower pH relative to the commercial formulation allows for easier handling.

A comparison of solutions 1 and 2, which contain no aqueous ammonia and differ only in that solution 2 includes sodium bicarbonate, is interesting. Solution 2 performed better than solution 1 in reducing E. coli. When fed at a rate of 1 ppm (as Cl₂), the microbial count for solution 1 was 1.10E+02, while no microorganisms were observed in the sample treated with solution 2. This shows that sodium bicarbonate improves the activity of biocides formed from ammonium salts even in the absence of aqueous ammonia.

In order to understand this effect, the control parameters for the formation of the biocides were examined. For solution 1, the pH maximum and ORP minimum were observed after addition of 140 mL sodium hypochlorite. For solution 2, which contained sodium bicarbonate, the pH maximum and ORP minimum were observed after addition of 150 mL sodium hypochlorite. This indicates that for the solution containing bicarbonate, more ammonia was available to react with the hypochlorite, which results in a higher concentration of biocide.

### Example 16

A biocide was prepared by titrating sodium hypochlorite with low alkalinity into a solution of ammonium bromide (about 4500 ppm). The results in Table 40 below show that with low alkalinity the biocide degrades as it is produced, and it is impossible to get to the equimolar point because due to the low pH, degradation occurs quickly even with an excess of ammonium bromide. The composition of the present invention would mitigate this problem since the pH of the composition is higher than the pH of the ammonium bromide solution.

TABLE 40

| Hypochlorite | | Conductivity, | | |
|---|---|---|---|---|
| added, mL | pH | mS/cm | ORP, mV | ORP/pH |
| 0 | 5.57 | 28 | 520 | 93.36 |
| 10 | 7.79 | 26 | 544 | 69.83 |
| 20 | 8.16 | 24 | 521 | 63.83 |
| 30 | 8.37 | 25 | 510 | 60.92 |
| 40 | 8.26 | 31 | 520 | 62.98 |

### Example 17

A biocide was prepared by titration of a 19.5% w/w ammonium carbamate solution containing 8% sodium hydroxide with a commercial sample of high alkalinity sodium hypochlorite, while measuring pH, ORP and conductivity. The sodium hypochlorite titrant was formed by diluting 6.6 mL of the commercial solution in 100 mL DI water. As can be seen in Table 41, the ORP/pH ratio, which is expected to decrease with increase in pH actually increased with increase in pH, showing that the biocide is degrading even when the ammonium carbamate is in high excess relative to sodium hypochlorite, and the pH is very high. Conductivity due to extra alkalinity is very high, too, and a maximum conductivity is reached before the real reaction end point due to the continuous degradation. The composition of the present invention would mitigate this problem since the pH of the composition is lower than the pH of the ammonium carbamate solution containing 8% sodium hydroxide and the conductivity is lower.

TABLE 41

| Hypochlorite | | Conductivity, | | |
|---|---|---|---|---|
| added, mL | pH | mS/cm | ORP, mV | ORP/pH |
| 30 | 12.70 | 44.9 | 72 | 1.60 |
| 50 | 12.76 | 47.3 | 186 | 3.93 |
| 70 | 12.81 | 48.4 | 216 | 4.46 |
| 80 | 12.83 | 49.0 | 248 | 5.06 |
| 90 | 12.84 | 49.1 | 251 | 5.11 |
| 100 | 12.86 | 49.0 | 252 | 5.14 |
| 110 | 12.87 | 38.4 | 252 | 6.56 |

### Example 18

To further elucidate the advantages of the present invention relative to a solution of ammonium carbamate containing 8% sodium hydroxide, two solutions were prepared. Solution 1 contained 20% ammonium carbamate and 8% sodium hydroxide. Solution 2 contained 15% w/w ammonium carbamate, 2.4% w/w ammonia and 2.5% w/v sodium bicarbonate. 2.3 ml of each solution were diluted in 30 ml sodium hypochlorite, and additional amounts of sodium hypochlorite were added while monitoring pH, conductivity and ORP. The results for Solutions 1 and 2 are shown in Tables 42 and 43, respectively.

TABLE 42

| Hypochlorite added, mL | pH | Conductivity, mS/cm | ORP, mV |
|---|---|---|---|
| 30 | 11.32 | 27.3 | 330 |
| 40 | 12.26 | 27.6 | 280 |
| 50 | 12.5 | 28.5 | 282 |
| 60 | 12.6 | 29.1 | 281 |
| 70 | 12.66 | 29.7 | 281 |
| 80 | 12.7 | 29.9 | 278.5 |
| 90 | 12.71 | 29.7 | 274.5 |
| 100 | 12.7 | 29 | 272.4 |
| 110 | 12.66 | 28.1 | 275 |
| 120 | 12.6 | 27.3 | 285 |

TABLE 43

| Hypochlorite added, mL | pH | Conductivity, mS/cm | ORP, mV |
|---|---|---|---|
| 30 | 9.87 | 26.3 | 400 |
| 40 | 9.9 | 23.2 | 400 |
| 50 | 10.03 | 21.4 | 397 |
| 60 | 10.21 | 20.4 | 388 |
| 70 | 10.48 | 19.76 | 380 |
| 80 | 10.95 | 19.51 | 364 |
| 90 | 11.75 | 20.1 | 330 |
| 100 | 12.1 | 21 | 313 |
| 110 | 12.29 | 22 | 305 |
| 120 | 12.38 | 22.9 | 296 |
| 130 | 12.41 | 23 | 287 |
| 140 | 12.39 | 22.7 | 291.8 |

In Solution 1, the conductivity maximum occurred at 80 mL hypochlorite, while in Solution 2, the conductivity maximum occurred at 130 mL hypochlorite. The pH in the biocide made from Solution 1 was high, which apparently causes degradation of the biocide to occur earlier. In the biocide made from Solution 2, the pH remains below 12.5, thus delaying the degradation of the biocide, and allowing the preparation of a larger amount of biocide from the same amount of ammonium carbamate. The composition comprising ammonium carbamate, aqueous ammonia and sodium bicarbonate obviates the need for adding sodium hydroxide, previously believed to be necessary to stabilize the ammonium carbamate, reduces the amount ammonium carbamate necessary, and leads to a more stable biocide.

It will be appreciated by persons skilled in the art that the present invention is not limited to what has been particularly shown and described hereinabove. Rather the scope of the present invention includes both combinations and subcombinations of various features described hereinabove as well as modifications thereof which would occur to a person of skill in the art upon reading the foregoing description and which are not in the prior art.

1. A composition for preparing a biocide, the composition comprising:
an ammonium salt comprising ammonium and an anion;
aqueous ammonia; and
sodium bicarbonate;
wherein a total molar amount of ammonia and ammonium in the composition exceeds an equivalent molar amount of the anion in the composition by at least 10%;
wherein the equivalent molar amount of the anion is a molar amount of the anion multiplied by its valence; and
wherein the concentration of the sodium bicarbonate is in a range of about 0.2% w/v to about 10% w/v.

2. The composition according to claim 1, wherein the ammonium salt is selected from the group consisting of ammonium bicarbonate, ammonium bromide, ammonium carbamate, ammonium carbonate, ammonium chloride, ammonium phosphate, ammonium sulfamate and ammonium sulfate.

3. (canceled)

4. The composition according to claim 1, wherein the ammonium salt is ammonium bromide or ammonium carbamate.

5. (canceled)

6. The composition according to claim 1, wherein the composition is an aqueous solution comprising the ammonium salt at a concentration in a range of about 4% w/w to about 36% w/w.

7. (canceled)

8. The composition according to claim 1, wherein the molar ratio of the ammonium salt to the aqueous ammonia is in a range of about 1:10 to about 10:1.

9. The composition according to claim 1, wherein the molar ratio of the ammonium salt to the aqueous ammonia is in a range of about 1:3 to about 3:1.

10-14. (canceled)

15. The composition according to claim 1, wherein the concentration of the aqueous ammonia is in a range of about 1% w/w to about 21% w/w.

16-17. (canceled)

18. The composition according to claim 1, wherein the concentration of the sodium bicarbonate is in a range of about 1% w/v to about 5% w/v.

19-26. (canceled)

27. A method of producing a biocide, comprising:
providing a solution of a hypochlorite oxidant;
providing a composition, the composition comprising:
an ammonium salt comprising ammonium and an anion;
aqueous ammonia; and
sodium bicarbonate;
wherein a total molar amount of ammonia and ammonium in the composition exceeds an equivalent molar amount of the anion in the composition by at least 10%;
wherein the equivalent molar amount of the anion is a molar amount of the anion multiplied by its valence; and
wherein the concentration of the sodium bicarbonate is in a range of about 0.2% w/v to about 10% w/v; and
mixing said solution of a hypochlorite oxidant with said composition.

28. The method according to claim 27, wherein said hypochlorite oxidant is sodium hypochlorite.

29-30. (canceled)

31. The method according to claim 27, wherein said solution of a hypochlorite oxidant has a concentration in a range of about 3500 to about 7000 ppm.

32-34. (canceled)

35. The method according to claim 27, wherein said composition is prepared by:
combining an ammonium salt stock solution, an aqueous ammonia stock solution and sodium bicarbonate to form a mixture; and
diluting the mixture with water or with said solution of a hypochlorite oxidant.

36-39. (canceled)

40. The method according to claim 35, wherein said ammonium salt stock solution and said aqueous ammonia stock solution are equimolar.

41-44. (canceled)

45. The method according to claim 27, further comprising monitoring a control parameter during said mixing.

46. The method according to claim 45, wherein said control parameter is selected from the group consisting of pH, oxidation-reduction potential (ORP), conductivity, dissolved oxygen saturation, and a ratio ORP/pH.

47. The method according to claim 46, wherein said control parameter is the ratio ORP/pH.

48. The method according to claim 46, wherein said control parameter is conductivity.

49. The method according to claim 48, wherein said mixing comprises:
adding said solution of a hypochlorite oxidant to said composition; and
ceasing to add said solution of a hypochlorite oxidant when the conductivity reaches a relative maximum.

50. The method according to claim 49, wherein the conductivity reaches a relative minimum prior to reaching the relative maximum.

51. The method according to claim 27, wherein the pH of the biocide remains below 12.5.
